(19) United States
(12) Patent Application Publication
(10) Pub. No.: US 2022/0351187 A1
(43) Pub. Date: Nov. 3, 2022

(54) SYSTEM AND METHOD FOR CLAIMING NON-FUNGIBLE TOKENS

(71) Applicant: STACK STATION, INC., Anaheim, CA (US)

(72) Inventor: Daniel KIM, Placentia, CA (US)

(21) Appl. No.: 17/733,910

(22) Filed: Apr. 29, 2022

Related U.S. Application Data
(60) Provisional application No. 63/182,711, filed on Apr. 30, 2021.

(51) Int. Cl. G06Q 20/36; H04L 9/32

(52) U.S. Cl. CPC G06Q 20/3674; G06Q 20/3678; H04L 9/3213; G06Q 2220/00; H04L 2209/60

(57) ABSTRACT

Aspects relate to providing an efficient way to claim a non-fungible token (NFT) associated with a physical object, such as a merchandise item. A user device may scan, using a scanning device, for access information of a physical object, and determine a link to an NFT associated with the physical object based on the scanned access information. Subsequently, the user device may transmit, to an NFT server device, an NFT command indicating the link and a user account of a user to cause the NFT to be claimed by the user account. Other aspects, embodiments, and features are also claimed and described.

### PRIORITY CLAIM

This application claims priority to and the benefit of provisional patent application No. 63/182,711 filed in the United States Patent & Trademark Office on Apr. 30, 2021, the entire content of which is incorporated herein by reference as if fully set forth below in its entirety and for all applicable purposes.

### TECHNICAL FIELD

The technology discussed below relates generally to electronic device systems, and more particularly, to claiming non-fungible tokens (NFTs).

### INTRODUCTION

With advancement of technology, various types of transactions are increasingly taken place in a digital space. For example, various purchases and transactions may take place digitally, and digital certificates and digital assets have been becoming more commonly used. Among digital assets, a non-fungible token (“NFT”) has been increasingly gaining attention. NFTs are cryptographical data that is stored such that only a particular individual may access them. Each NFT is unique and cannot be replicated. Hence, NFTs have been used to represent particular objects, and have often been used to show authenticity and/or ownership of the particular objects. However, NFTs are still new to the general public. For this reason, even when NFTs are available to claim, many NFTs may go unclaimed because many people are not familiar with the NFTs.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method of claiming one or more non-fungible tokens (NFTs) by a user device is disclosed. The method includes scanning, using a scanning device, for access information of a physical object, determining a link to an NFT associated with the physical object based on the scanned access information, and transmitting, to an NFT server device, an NFT command indicating the link and a user account of a user to cause the NFT to be claimed by the user account.

In another example, a user device for claiming one or more NFTs is disclosed. The user device includes at least one processor, a communication device communicatively coupled to the at least one processor, and a memory communicatively coupled to the at least one processor. The at least one processor may be configured to: scan, using a scanning device, for access information of a physical object, determine a link to an NFT associated with the physical object based on the scanned access information, and transmit, to an NFT server device, an NFT command indicating the link and a user account of a user to cause the NFT to be claimed by the user account.

In another example, a non-transitory processor-readable storage medium having instructions for a user device thereon may be disclosed. The instructions, when executed by a processing circuit, cause the processing circuit to: scan, using a scanning device, for access information of a physical object, determine a link to an NFT associated with the physical object based on the scanned access information, and transmit, to an NFT server device, an NFT command indicating the link and a user account of a user to cause the NFT to be claimed by the user account.

In a further example, a user device for claiming one or more NFTs may be disclosed. The user device includes means for scanning, using a scanning device, for access information of a physical object, means for determining a link to an NFT associated with the physical object based on the scanned access information, and means for transmitting, to an NFT server device, an NFT command indicating the link and a user account of a user to cause the NFT to be claimed by the user account.

In one example, a method of claiming one or more NFTs by an NFT server device is disclosed. The method includes receiving, from a user device, an NFT command indicating a link to an NFT associated with a physical object and a user account of a user, wherein the link is based on scanned access information of the physical object, and causing the NFT to be claimed by the user account in response to the NFT command.

In another example, an NFT server device for claiming one or more NFTs is disclosed. The NFT server device includes at least one processor, a communication device communicatively coupled to the at least one processor, and a memory communicatively coupled to the at least one processor. The at least one processor may be configured to: receive, from a user device, an NFT command indicating a link to an NFT associated with a physical object and a user account of a user, wherein the link is based on scanned access information of the physical object, and cause the NFT to be claimed by the user account in response to the NFT command.

In another example, a non-transitory processor-readable storage medium having instructions for an NFT server device thereon may be disclosed. The instructions, when executed by a processing circuit, cause the processing circuit to: receive, from a user device, an NFT command indicating a link to an NFT associated with a physical object and a user account of a user, wherein the link is based on scanned access information of the physical object, and cause the NFT to be claimed by the user account in response to the NFT command

In a further example, an NFT server device for claiming one or more NFTs may be disclosed. The NFT server includes means for receiving, from a user device, an NFT command indicating a link to an NFT associated with a physical object and a user account of a user, wherein the link is based on scanned access information of the physical object, and means for causing the NFT to be claimed by the user account in response to the NFT command.

These and other aspects of the disclosure will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is an example diagram illustrating an interaction with a user device to claim a non-fungible token (NFT) for a physical object, according to some aspects.

FIGS. 2A and 2B are example diagrams illustrating different ways the access information of physical objects may be scanned, according to some aspects.

FIGS. 3A, 3B, 3C, and 3D are example diagrams illustrating a process to claim an NFT associated with a physical object, according to some aspects.

FIGS. 4A and 4B are block diagrams conceptually illustrating hardware implementations of a system to claim an NFT for a physical object, according to some aspects.

FIGS. 5A and 5B are flow charts illustrating an exemplary process for claiming one or more NFTs by a user device, according to some aspects.

FIGS. 6A and 6B are flow charts illustrating an exemplary process for claiming one or more NFTs by an NFT server device, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. It is intended that innovations described herein may be practiced in a wide variety of devices, chip-level components, systems, distributed arrangements, end-user devices, etc. of varying sizes, shapes and constitution.

A non-fungible token (“NFT”) is a cryptographical asset, where each NFT is unique and cannot be replicated. The NFT may carry information such as an object and/or a file linked to the NFT, a current owner, a ownership history, etc. In an example, an NFT may store such information on a blockchain. Hence, in this example, the transactions related to NFTs may be recorded on the blockchain.

NFTs were widely used for digital items, such as digital art. More recently, there have been attempts to utilize to associate an NFT to a physical object. For example, NFTs are starting to be used with physical objects, such as baseball cards. In this example, the NFT is often used to provide authenticity and/or ownership of a physical object with which the NFT is associated. However, the general public is not familiar with NFTs and may have difficulty in learning how to obtain NFTs. For example, when a user acquires or purchases a physical object, the user may not know how to obtain an NFT associated with the physical object. Instructions may be provided to the user such that the user may be able to visit an NFT-related website to claim the NFT associated with the physical object. However, this may be a cumbersome and complicated process for the user, and thus the user may be unmotivated to claim the NFT associated with the physical object. As a result, many NFTs that should be claimed by user(s) may stay unclaimed, which is not an efficient use of resources. For example, unclaimed NFTs may take up blockchain spaces, and thus may waste the blockchain space without being ever claimed. Therefore, an approach to enable a user to easily claim an NFT associated with an physical object is desired to help the user with claiming the NFT and to make efficient use of the resources allocated for NFTs.

According to some aspects of the disclosure, a user device (e.g., mobile device, cellular phone) may be used to scan for access information of a physical object, such that the user device may determine a link to an NFT associated with the physical object based on the scanned access information of the physical object. In an example, the access information may be provided in a form of a graphical code such as a barcode (e.g., QR code) on the physical object, such that the user device may be used to scan the graphical code to read the access information. After determining the link to the NFT, the user device may transmit an NFT command to an NFT server, where the NFT command indicates the link and a user account of a user such that the NFT may be claimed by the user account at the NFT server. As such, using this approach, the user may be able to easily claim the NFT associated with the physical object without much difficulty, and thus the rate of the NFTs being timely claimed may be high. Because this approach allows users to easily claim the NFTs, the number of unclaimed NFTs will be reduced and thus the resources for maintaining the NFTs may be used efficiently.

For example, when a user uses the user device to scan a barcode on the physical object, the user device may display a webpage where the user can redeem an NFT associated with the physical object. In some examples, the webpage may provide an option to create a digital wallet (e.g., using an email) to store the NFT and/or an option to link the NFT with an existing digital wallet to store the NFT. With one click, the user can log on using the user device and cause the NFT associated with the physical object to be transferred to the user account of the user. Various aspects of the disclosure are provided as follows.

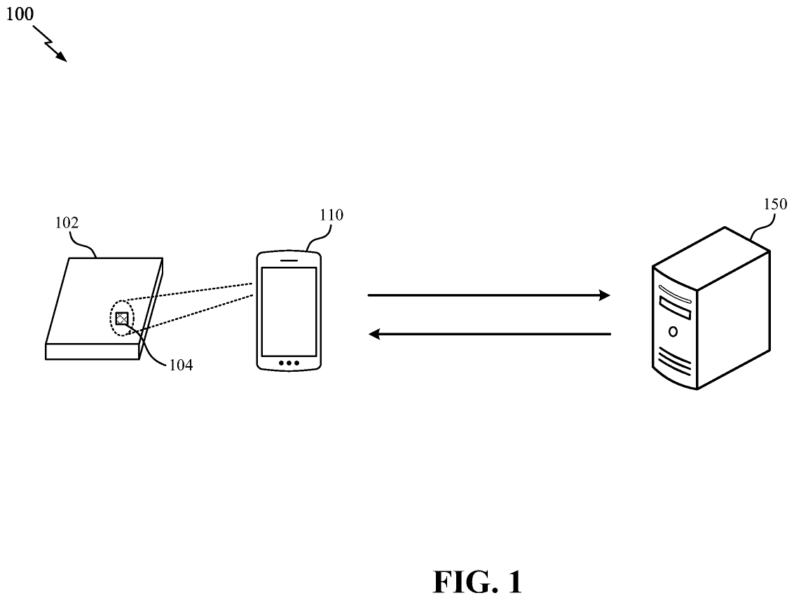

FIG. 1 is an example diagram illustrating an interaction with a user device to claim an NFT for a physical object, according to some aspects.

As shown in FIG. 1, a physical object 102 may have an access information portion 104 that includes access information of the physical object 102. In another aspect not illustrated in FIG. 1, the physical object 102 may have the access information portion that is separate from the physical object 102. In an example, the physical object 102 may be a merchandise that the user may purchase, such as a baseball card, shoes, art work, etc. In this example, the user may be able to claim the NFT after purchasing and obtaining ownership of the physical object 102.

In the example illustrated in FIG. 1, a user device 110 may be an electronic device with a user interface, such as a tablet computer, a mobile computer, a mobile phone, etc. The user device 110 may include a scanning device or may be connected to a scanning device, where the user device 110 may utilize the scanning device to scan for access information of the physical object 102, e.g., by scanning the access information portion 104 that includes the access information. The user device 110 may also have a communication device to communicate with an NFT server device 150, and may be able to connect to the Internet. In some aspects, the user device 110 may be capable of wireless communication to connect to the Internet and/or to communicate with other devices such as the NFT server device 150.

The user device 110 utilizing the scanning device may be able to scan for the access information and determine a link to an NFT associated with the physical object 102 based on the scanned access information. In some aspects, the link may indicate a web address (e.g., uniform resource locator (URL) to claim the NFT.

After determining the link to the NFT associated with the physical object, the user device 110 may transmit an NFT command to an NFT server device 150, where the NFT command indicates the link to the NFT and a user account of a user to cause the NFT to be claimed by the user account. In some aspects, when the NFT has been claimed by the user account, the user device 110 may receive (e.g., from the NFT server device 150) an indication that the NFT has been claimed by the user account, and subsequently may display a visual representation associated with the physical object and the NFT (e.g., on a display device). In some aspects, the transactions related to the NFT, such as the NFT being claimed by the user account, may be recorded on the blockchain.

In some aspects, the user device 110 may display a claim option that may be selected to claim the NFT. For example, the claim option may be displayed as a button to select by the user. When the user device 110 receives an input to select the claim option to claim the NFT, the user device 110 may transmit the NFT command to the NFT server device 150 in response to receiving the input to select the claim option.

Accordingly, the NFT associated with the physical object 102 may be claimed easily by allowing the NFT to be claimed by the user account based on the link determined based on the scanned access information. Because some aspects of the disclosure provide a simple way to claim the NFT associated with the physical object 102, users may be more motivated to claim NFTs for their physical objects and thus a number of unclaimed NFTs may be reduced. By reducing the number of unclaimed NFTs associated with the physical objects, more efficient use of resources can be achieved.

In some aspects, the user device 110 may display digital wallet(s) with which to associate the NFT. In one example, the user device 110 may display the digital wallet(s) after the claim option is selected and/or the NFT command is transmitted. When the user device 110 receives an input to select a digital wallet out of the displayed digital wallet(s), the selected digital wallet may be associated with the NFT (e.g., by the NFT server device 150). For example, the NFT may be stored in the selected digital wallet. In some aspects, the user may need to input a user identification and a password on the user device 110 to access the selected digital wallet. In some aspects, the user device 110 may display an option to create a new digital wallet to store the NFT. If the user may select this option to create a new digital wallet, the user may be requested to provide information to create a new digital wallet, such as a user identification, a password, etc. In some aspects, because the user device 110 may automatically provide options related to digital wallets after the NFT is claimed based on the link determined based on the scanned access information, the process is streamlined from scanning of the access information to the storing of the NFT in the digital wallet.

In a use example, when the user scans for the access information of the physical object 102 (e.g., by scanning the barcode or the electronic chip), the user device may read the access information and determine the link to the NFT based on the access information. Subsequently, the user device 110 may display a page where the user can claim the NFT associated with the physical object 102. In some cases, the user device 110 may provide an option to create a digital wallet (e.g., using an email) or to associate the NFT with an existing digital wallet of the user. Hence, after the scanning, with one or two clicks, the user can claim the NFT associated with the physical object 102 in the user account. Hence, as explained in this use example, this approach may streamline the process of claiming the NFT associated with the physical object 102 by simplifying the steps to claim the NFT.

In some aspects, after the NFT associated with the physical object has been claimed by the user account, the user device 110 may be used to perform another scan for the access information of the physical object. In an aspect, the subsequent scan may indicate that the ownership of the NFT is to be transferred to another user account. In this aspect, the user device 110 may receive an ownership transfer command associated with a second user account. In one example, when the subsequent scan is performed, the user device 110 may enable the user to indicate the second user account by inputting the ownership transfer command indicating the second user account to the user device 110. In response to receiving the ownership transfer, the user device 110 may transmit (e.g., to the NFT server device 150) an ownership transfer request according to the link to the NFT, where the ownership transfer request indicates the second user account. When the NFT server device 150 receives the ownership transfer request, the ownership transfer request may cause the NFT server device 150 to transfer ownership of the NFT from the user account to the second user account.

In some aspects, a subsequent scan may cause the user device 110 to verify the ownership of the NFT. In an aspect, when the subsequent scan after the NFT associated with the physical object has been claimed is performed, the user device 110 may transmit (e.g., to the NFT server device 150) a verification request according to the link, and may receive (e.g., from the NFT server device 150) the verification information to verify ownership of the NFT by the user account. In an aspect, the verification information may be displayed at the user device 110.

In some aspects, after the NFT associated with the physical object has been claimed, the subsequent scan will not allow the scanning user to claim the corresponding NFT again. For example, once the NFT associated with the physical object has been claimed, the link to the NFT may be disabled to prevent the NFT from being claimed again.

In an aspect, the access information of the physical object 102 in the access information portion 104 may be a barcode, such as a QR code. For example, as the access information portion 104, the bar code may be located (e.g., printed) on the physical object 102 and/or may be separately provided (e.g., on a display device, on a website, on a separate paper). In this aspect, the scanning device for scanning the barcode may be a laser barcode scanner or an image capturing device (e.g., camera) to capture the barcode. In some aspects, the barcode may be scanned using a generic camera application on a mobile device (e.g., mobile phone) for the access information. In some aspects, the barcode may be scanned using a specialized mobile application (e.g., one developed and/or otherwise associated with the creator of the NFT and/or the physical object). When the user device 110 detects and reads the barcode, the user device 110 may determine a link to the NFT by translating the barcode into the link that can be used to claim the NFT.

In an aspect, the access information of the physical object may be included in an electronic chip embedded in the physical object. For example, the access information may be stored in an electronic chip that can be read contactlessly or wirelessly, such as a near field communication (NFC) chip, a radio frequency identification (RFID) chip, etc. In this aspect, the scanning device may be a chip reading device configured to wirelessly read the access information from the electronic chip.

In some aspects, the access information portion 104 may be initially blocked from a scan, in order to avoid undesired or unintended scanning of the access information portion 104. For example, if the access information portion 104 is a barcode, the barcode may be covered with a scratchable or removable film. For example, if the access information portion 104 is an electronic chip, the electronic chip may be surrounded by an enclosure that blocks signals from/to a chip scanning device. In an example, if the user acquires the physical object 102 via an online transaction (e.g., online shopping), the physical object 102 may be shipped to the user and the user may scan the access information portion 104 on the physical object 102 and/or the online transaction page where the online transaction was performed may provide the QR code on its page upon completion of the online transaction.

In some aspects, the NFT associated with the physical object 102 may be generated before a user can have access to the physical object 102 (e.g., before the user can purchase the physical object 102). The NFT may be used in connection with the physical object 102 and/or may represent the physical object 102. In some cases, the NFT associated with the physical object 102 may be claimed only by a user who has acquired the physical object 102, such as a user who has the ownership of the physical object 102. In an example, the user may have the ownership of the physical object 102 after the user purchases the physical object 102.

In some aspects, the NFT associated with the physical object 102 may be associated with certain visual characteristics that represent those of the physical object 102. For example, if the physical object is a physical baseball card, the NFT may be associated with a digital image or a virtual 2-D or 3-D artwork/sculpture of the physical baseball card. If a 2-D digital image is used as the visual representation, the user may be able to flip the 2-D digital image associated with the NFT to view the other side of the 2-D digital image. If a virtual 3-D artwork/sculpture is used as the visual representation, the user may be able to rotate or maneuver the virtual 3-D artwork/sculpture associated with the NFT to view all sides of the 3-D artwork/sculpture. In some cases, the visual representation may be a digital graphical icon or artwork that resembles but looks different from the physical object 102.

In some aspects, the link to the NFT may be generated before a user can have access to the physical object 102. In an example, the NFT may be generated by an NFT platform. The link to the NFT may be used to transfer the NFT to a user account associated with the user. Such a link can allow the user accessing the link to claim the NFT associated with the link. In some cases, the link and/or the NFT may be associated with additional conditions or restrictions that need to be satisfied before the NFT tied to the link can be successfully claimed using the link. For example, the link and/or the NFT may be associated with a user identifier of a user who is permitted to claim the NFT

In some aspects, the user may be able to scan for the access information of the physical object 102 only after the user acquires the physical object 102 (e.g., by taking possession of the physical object 102). For example, the user may acquire the physical object 102 by purchasing the physical object 102 at a physical store or from an online store that ships the physical object 102 to the user.

In some cases, when the user takes possession of the physical object (e.g., by purchasing the physical object), an identifier associated with the user may be registered on the a platform and associated with the NFT corresponding to the physical object. This identifier may be used to confirm that the user claiming the NFT is indeed the user who took physical possession of the physical object.

In an aspect, the user device 110 may perform an authentication process to check whether an intended user account is attempting to claim the NFT. For example, the authentication process may check whether the user is logged into the platform and/or whether the user's account on the platform matches the intended recipient of the NFT. In this aspect, the user device 110 may receive, from the NFT server device 150, an authentication request associated with the NFT. In response, the user device 110 may transmit authentication information to the NFT server device 150. For example, the user may input the authentication information into the user device 110 such that the user device 110 may transmit the authentication information. In an example, the authentication information may include a user account identification and an associated password. In another example, the authentication information may be a code that is provided to the user (e.g., by a merchant) to input when the user acquires the physical object 102. In this aspect, the NFT may be claimed by the user account based on the authentication information. For example, the NFT server device 150 may cause the NFT to be claimed by the user account only after the authentication information is verified as correct information. In an example, the authentication information may be a user identification and a password for the user account and may be provided using the user device. The authentication process may ensure that only the intended user may be able to claim the NFT associated with the physical object 102 for the user account.

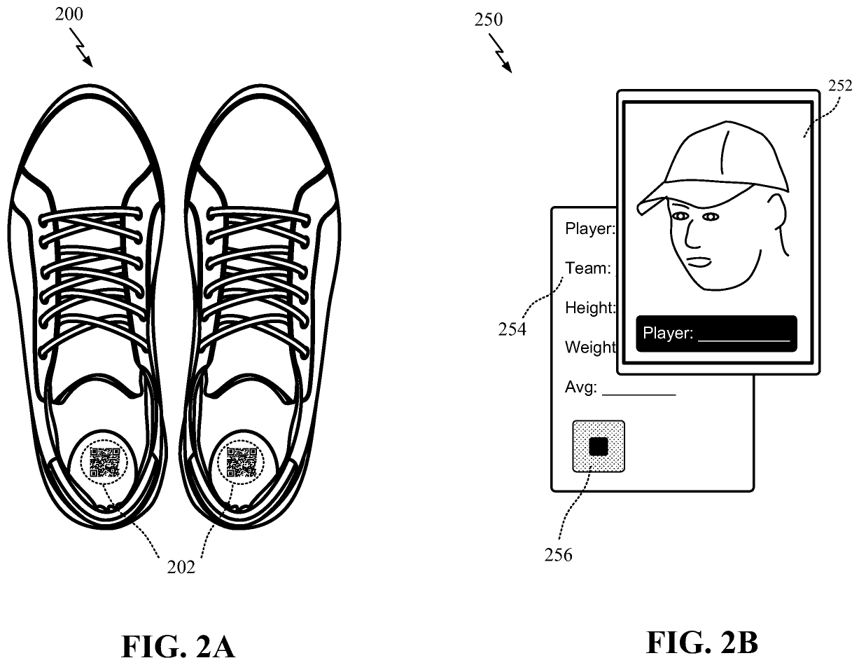

FIGS. 2A and 2B are example diagrams illustrating different ways the access information of physical objects may be scanned, according to some aspects. FIG. 2A is an example diagram 200 illustrating a QR code printed on shoes, according to some aspects. As shown in FIG. 2A, a QR code 202 is printed on soles of the shoes, such that a user device may be used to scan the QR code 202 for access information of the shoes. FIG. 2B is an example diagram 250 illustrating a chip embedded in a baseball card, according to other aspects. As shown in FIG. 2B, a front side 252 of the baseball card may show a picture of a baseball player and the player's name. A reverse side 254 of the baseball card may show information about the baseball player such as statistics. The reverse side 254 may also include an access information portion 256 that includes an RFID chip having access information of the baseball card, where the access information can be read wirelessly from the RFID chip by a user device scanning for the access information.

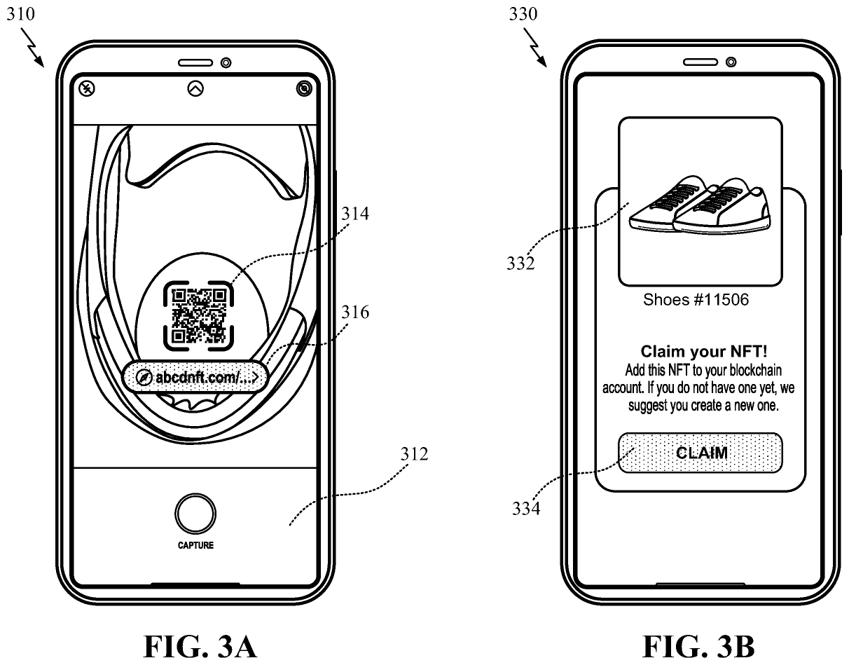

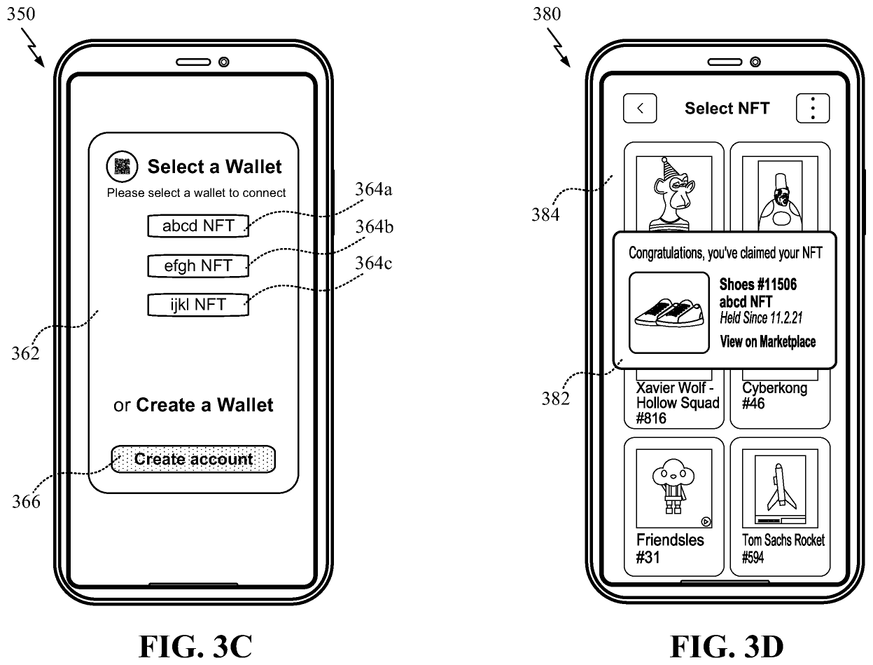

FIGS. 3A, 3B, 3C, and 3D are example diagrams illustrating a process to claim an NFT associated with a physical object, according to some aspects. In the example diagrams of FIGS. 3A, 3B, 3C, and 3D, the QR code of the shoes of FIG. 2A is scanned by the user device for the access information of the shoes.

FIG. 3A is an example diagram 310 illustrating a process of scanning the QR code for access information of the NFT associated with the physical object, according to some aspects, In FIG. 3A, the user may use a camera application 312 of the user device to scan for the access information from the QR code on the shoes. In particular, in FIG. 3A, the user device utilizes the camera application 312 to scan the QR code 314 for the access information of the shoes. For example, the user may point the user device toward the shoes such that at least the QR code portion of the shoes is within the camera's field of view and displayed on the display screen of the user device. After scanning the QR code for the access information, the user device may determine a link 316 to an NFT associated with the shoes based on the scanned access information from the QR code, and may present information about the link 316 on the display of the user device. The user device may automatically access the link 316 or may access the link when the user manually selects the link 316.

FIG. 3B is an example diagram 360 illustrating a process of claiming the NFT, according to some aspects. After determining the link 316 to the NFT based on the scanned access information from the QR code, the user device may transmit an NFT command (e.g., to an NFT server) indicating the link and a user account of the user. Subsequently, the NFT server may cause the NFT associated with the shoes to be claimed by the user account. In some aspects, as shown in FIG. 3B, the user device may show a visual representation 332 of the shoes and may display a claim option 334 to claim the NFT associated with the shoes. When the user selects the claim option 334, the user device may transmit the NFT command to the NFT server, to cause the NFT to be claimed by the user account. In an alternative aspect not shown in FIG. 3B, the user device may automatically transmit the NFT command to the NFT server after determining the link, without requiring the user manually selecting a claim button.

In some cases, an authentication process may be performed before the claim option 334 of claiming the NFT is presented to the user. For example, the authentication process may involve the user device communicating with the NFT server to check whether the user is logged into the platform and/or whether the user's account on the platform matches the intended recipient of the NFT. In this example, only after the authentication process is performed successfully, the claim option 334 may be presented to the user on the user device.

FIG. 3C is an example diagram 350 illustrating a process of selecting a digital wallet to store the NFT, according to some aspects. In FIG. 3C, after the user selects the claim button in FIG. 3B, the user device may display a wallet selection window 362 listing digital wallet options 364a, 364b, 364c, to enable the user to select one of three digital wallets. Upon selecting a digital wallet option, the NFT may be stored in the digital wallet corresponding to the selected digital wallet option. Further, the wallet selection window 362 may also provide an account create option 366 to create a new wallet account to store the NFT. In other examples not illustrated in FIG. 3C, the NFT may be stored automatically at a default digital wallet or a default storage location, without the user selecting a specific digital wallet.

FIG. 3D is an example diagram 380 illustrating a visualization of an NFT collection and an NFT claim indication, according to some aspects. When the NFT associated with the shoes is claimed by the user account, the user device may display an NFT claim indication 382 indicating that the NFT has been claimed. In some aspects, the NFT claim indication 382 may also show a digital wallet where the NFT is stored, and may show a date when the NFT is claimed. In the background, the user device may display an NFT collection 384 that shows various NFTs and their respective visualizations that have been claimed by the user account.

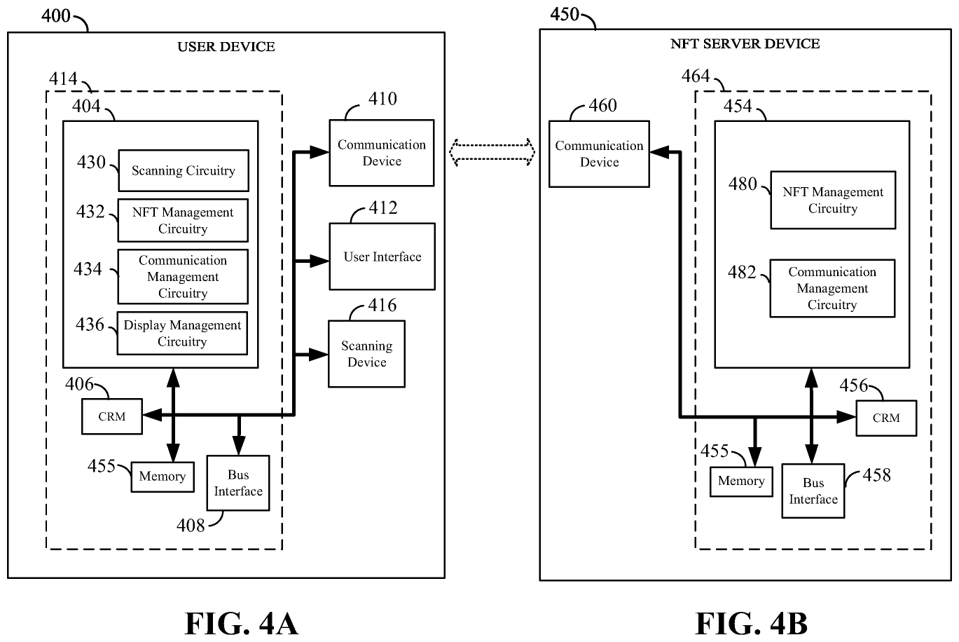

FIGS. 4A and 4B are block diagrams conceptually illustrating hardware implementations for a system to claim an NFT for a physical object, according to some aspects. The system shown in FIGS. 4A and 4B includes a user device 400 of FIG. 4A and an NFT server device 450 of FIG. 4B that are configured to communicate with each other.

FIG. 4A is a block diagram illustrating an example of a hardware implementation for the user device 400 employing a processing system 414. In an example, the user device 400 may be equivalent to the user device 110 of FIG. 1.

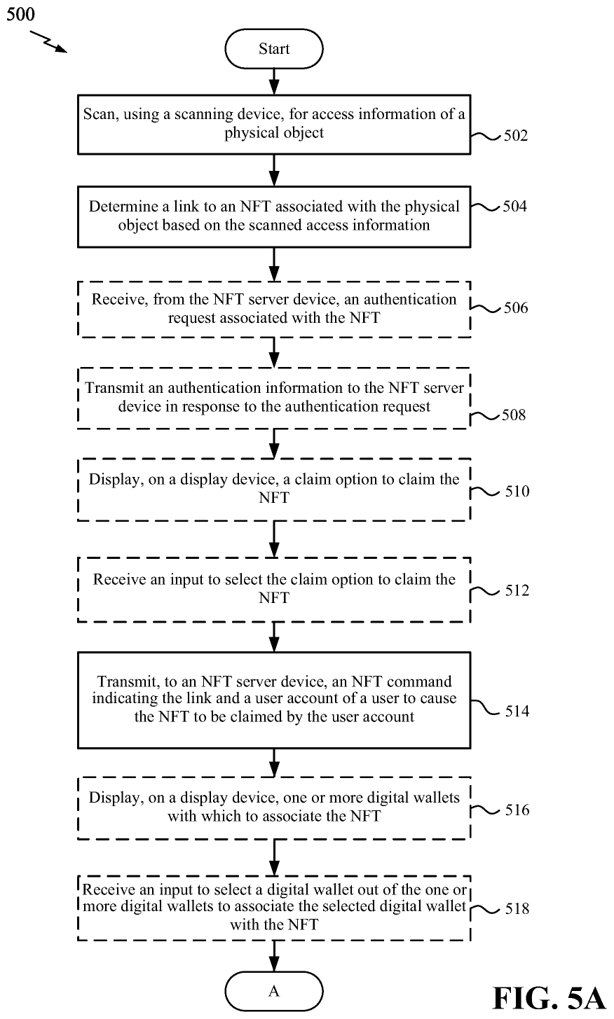

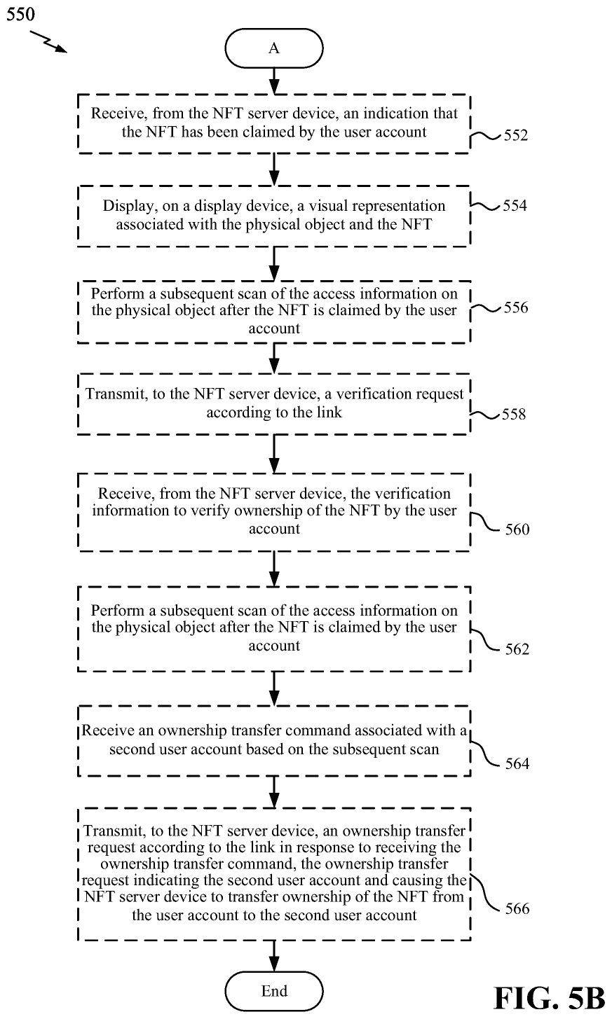

The user device 400 may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the user device 400 may be configured to perform any one or more of the functions described herein. That is, the processor 404, as utilized in a user device 400, may be used to implement any one or more of the processes and procedures described below and illustrated in FIGS. 5A and 5B.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and a computer-readable storage medium 406. The bus 402 may also link various other circuits such as timing sources, peripherals, voltage regulators, and power management circuits, which are well known in the art, and therefore, will not be described any further. A bus interface 408 provides an interface between the bus 402 and a communication device 410. The communication device 410 provides a communication interface or means for communicating with various other apparatus over a transmission medium. Depending upon the nature of the apparatus, a user interface 412 (e.g., keypad, display, speaker, microphone, joystick) and a scanning device 416 (e.g., a camera, a barcode scanner, a chip scanner, etc.) may also be provided.

In some aspects of the disclosure, the processor 404 may include scanning circuitry 430 configured for various functions, NFT management circuitry 432 configured for various functions, communication management circuitry 434 configured for various functions, and display management circuitry 436 configured for various functions.

For example, the scanning circuitry 430 may scan, using the scanning device 416, for access information of a physical object, the NFT management circuitry 432 may determine a link to an NFT associated with the physical object based on the scanned access information, and the NFT management circuitry 432 and the communication management circuitry 434 may transmit, to the NFT server device 450, an NFT command indicating the link and a user account of a user to cause the NFT to be claimed by the user account, using the communication device 410.

In an aspect, the communication management circuitry 434 may receive, from the NFT server device 450, an authentication request associated with the NFT, and the NFT management circuitry 432 may cause the communication management circuitry 434 to transmit an authentication information to the NFT server device 450 in response to the authentication request. In this aspect, the NFT may be claimed by the user account based on the authentication information.

In an aspect, the display management circuitry 436 may display, on a display device of the user interface 412, a claim option to claim the NFT, and the NFT management circuitry 432 may receive an input (e.g., via the user interface 412) to select the claim option to claim the NFT. In this aspect, the NFT command may be transmitted in response to receiving the input to select the claim option.

In an aspect, the display management circuitry 436 may display, on the display device of the user interface 412, one or more digital wallets with which to associate the NFT, and the NFT management circuitry 432 may receive an input (e.g., via the user interface 412) to select a digital wallet out of the one or more digital wallets to associate the selected digital wallet with the NF.

In an aspect, the communication management circuitry 434 may receive, from the NFT server device 450, an indication that the NFT has been claimed by the user account, and the display management circuitry 436 may display, on a display device of the user interface 412, a visual representation associated with the physical object and the NFT.

In an aspect, the scanning circuitry 430 may perform a subsequent scan of the access information on the physical object after the NFT is claimed by the user account, the NFT management circuitry 432 working with the communication management circuitry 434 may transmit, to the NFT server device 450, a verification request according to the link. Then, the communication management circuitry 434 may receive, from the NFT server device 450, the verification information to verify ownership of the NFT by the user account.

In an aspect, the scanning circuitry 430 may perform a subsequent scan of the access information on the physical object after the NFT is claimed by the user account, and the NFT management circuitry 432 may receive an ownership transfer command associated with a second user account based on the subsequent scan. Then, the NFT management circuitry 432 using the communication management circuitry 434 may transmit, to the NFT server device 450, an ownership transfer request according to the link in response to receiving the ownership transfer command, the ownership transfer request indicating the second user account and causing the NFT server device to transfer ownership of the NFT from the user account to the second user account.

The processor 404 is responsible for managing the bus 402 and general processing, including the execution of software stored on the computer-readable storage medium 406. The software, when executed by the processor 404, causes the processing system 414 to perform the various functions described above and/or below for any particular apparatus. The computer-readable storage medium 406 and the memory 405 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 406. The computer-readable storage medium 406 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 406 may reside in the processing system 414, external to the processing system 414, or distributed across multiple entities including the processing system 414. The computer-readable storage medium 406 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

FIG. 4B is a conceptual diagram illustrating an example of a hardware implementation for an exemplary NFT server device 450 employing a processing system 464. In accordance with various aspects of the disclosure, an element, or any portion of an element, or any combination of elements may be implemented with a processing system 464 that includes one or more processors 454.

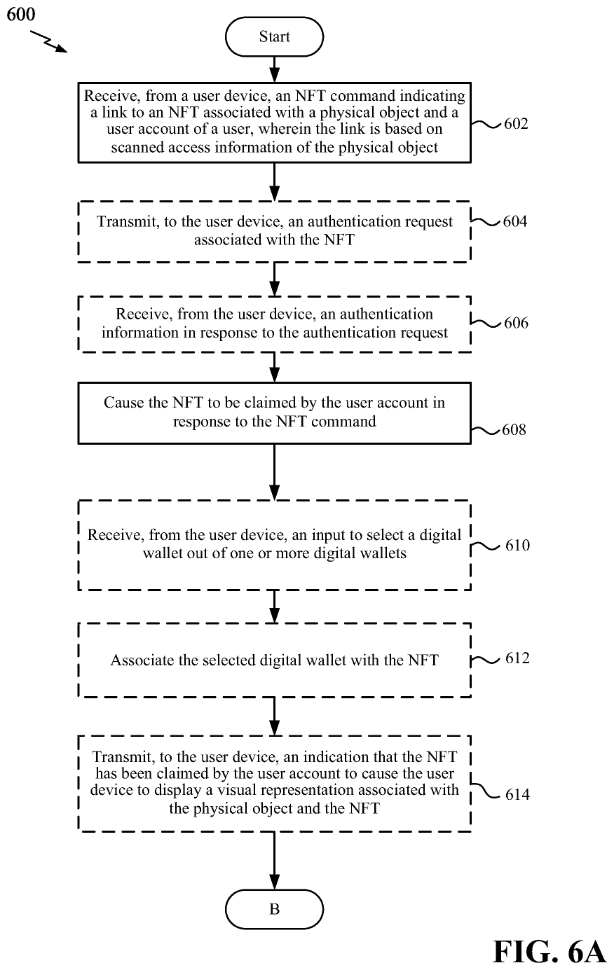

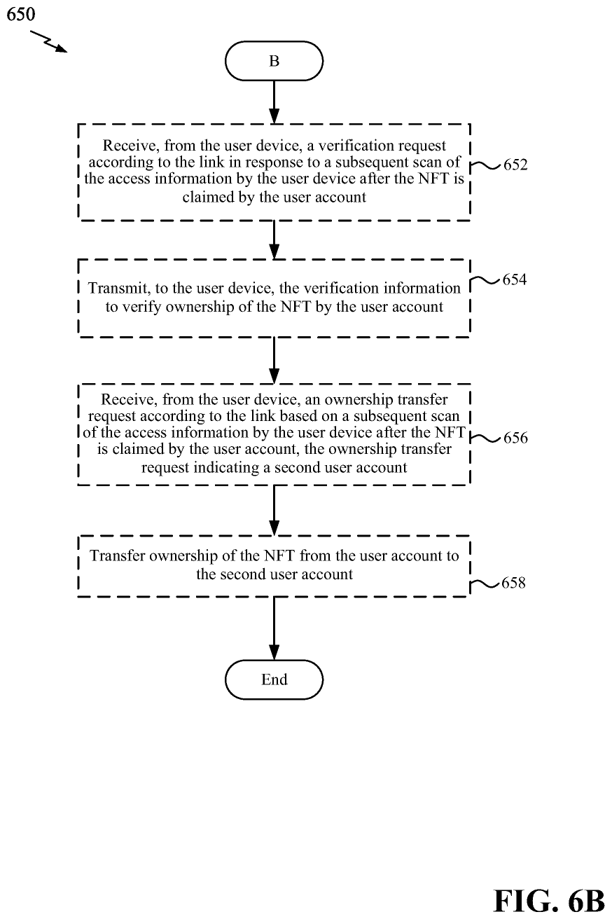

The NFT server device 450 may be implemented with a processing system 464 that includes one or more processors 454. Examples of processors 454 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the NFT server device 450 may be configured to perform any one or more of the functions described herein. That is, the processor 454, as utilized in an NFT server device 450, may be used to implement any one or more of the processes and procedures described below and illustrated in FIGS. 6A and 6B.

In this example, the processing system 464 may be implemented with a bus architecture, represented generally by the bus 452. The bus 452 may include any number of interconnecting buses and bridges depending on the specific application of the processing system 464 and the overall design constraints. The bus 452 communicatively couples together various circuits including one or more processors (represented generally by the processor 454), a memory 455, and a computer-readable storage medium 456. The bus 452 may also link various other circuits such as timing sources, peripherals, voltage regulators, and power management circuits, which are well known in the art, and therefore, will not be described any further. A bus interface 858 provides an interface between the bus 452 and a communication device 460. The communication device 460 provides a communication interface or means for communicating with various other apparatus over a transmission medium.

In some aspects of the disclosure, the processor 454 may include NFT management circuitry 480 configured for various functions and communication management circuitry 482 configured for various functions.

For example, the NFT management circuitry 480 and the communication management circuitry 482 may receive, from the user device 400, an NFT command indicating a link to an NFT associated with a physical object and a user account of a user, using the communication device 460, wherein the link is based on scanned access information of the physical object, and the NFT management circuitry 480 may cause the NFT to be claimed by the user account in response to the NFT command. In an aspect, the NFT management circuitry 480 using the communication management circuitry 482 may transmit, to the user device, an indication that the NFT has been claimed by the user account to cause the user device to display a visual representation associated with the physical object and the NFT.

In an aspect, the NFT management circuitry 480 using the communication management circuitry 482 may transmit, to the user device 400, an authentication request associated with the NFT. Then, the NFT management circuitry 480 using the communication management circuitry 482 may receive, from the user device 400, an authentication information in response to the authentication request.

In an aspect, the NFT management circuitry 480 using the communication management circuitry 482 may receive, from the user device 400, an input to select a digital wallet out of one or more digital wallets, and the NFT management circuitry 480 may associate the selected digital wallet with the NFT.

In an aspect, the NFT management circuitry 480 using the communication management circuitry 482 may receive, from the user device 400, a verification request according to the link in response to a subsequent scan of the access information by the user device after the NFT is claimed by the user account. Then, the NFT management circuitry 480 using the communication management circuitry 482 may transmit, to the user device 400, the verification information to verify ownership of the NFT by the user account.

In an aspect, the NFT management circuitry 480 using the communication management circuitry 482 may receive, from the user device 400, an ownership transfer request according to the link based on a subsequent scan of the access information by the user device after the NFT is claimed by the user account, the ownership transfer request indicating a second user account. Then, the NFT management circuitry 480 may transfer ownership of the NFT from the user account to the second user account.

The processor 454 is responsible for managing the bus 452 and general processing, including the execution of software stored on the computer-readable storage medium 456. The software, when executed by the processor 454, causes the processing system 464 to perform the various functions described above and/or below for any particular apparatus. The computer-readable storage medium 456 and the memory 455 may also be used for storing data that is manipulated by the processor 454 when executing software.

One or more processors 454 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 456. The computer-readable storage medium 456 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 456 may reside in the processing system 464, external to the processing system 464, or distributed across multiple entities including the processing system 464. The computer-readable storage medium 456 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

FIG. 5A is a flow chart illustrating an exemplary process 500 for claiming one or more NFTs by a user device, according to some aspects. As described below, some or all illustrated features may be omitted in a particular implementation within the scope of the present disclosure, and some illustrated features may not be required for implementation of all embodiments. In some examples, the process 500 may be carried out by the user device 400 illustrated in FIG. 4A. In some examples, the process 500 may be carried out by any suitable apparatus or means for carrying out the functions or algorithm described below.

At block 502, the user device scans, using a scanning device, for access information of a physical object. For example, the scanning circuitry 430 shown and described above in connection with FIG. 4A may provide means for scanning for the access information.

At block 504, the user device determines a link to an NFT associated with the physical object based on the scanned access information. For example, the NFT management circuitry 432 shown and described above in connection with FIG. 4A may provide means for determining the link. In an aspect, the link may indicate a web address to claim the NFT.

In an aspect, the access information may be a bar code associated with the physical object. In this aspect, the bar code may be printed on the physical object, and wherein the scanning device is an image capturing device configured to capture the bar code.

In aspect, the access information may be included in an electronic chip embedded in the physical object, and the scanning device may be a chip reading device configured to wirelessly read the access information from the electronic chip.

In an aspect, at block 506, the user device may receive, from the NFT server device, an authentication request associated with the NFT. For example, the communication management circuitry 434 shown and described above in connection with FIG. 4A may provide means for receiving the authentication request.

In an aspect, at block 508, the user device may transmit an authentication information to the NFT server device in response to the authentication request. For example, the NFT management circuitry 432 and the communication management circuitry 434 shown and described above in connection with FIG. 4A may provide means for transmitting the authentication information. In this aspect, the NFT may be claimed by the user account based on the authentication information.

In an aspect, at block 510, the user device may display, on a display device, a claim option to claim the NFT. For example, the display management circuitry 436 shown and described above in connection with FIG. 4A may provide means for displaying the claim option.

In an aspect, at block 512, the user device may receive an input to select the claim option to claim the NFT. In this aspect, the NFT command may be transmitted in response to receiving the input to select the claim option. For example, the NFT management circuitry 432 shown and described above in connection with FIG. 4A may provide means for receiving the input to select the claim option.

At block 514, the user device transmits, to an NFT server device, an NFT command indicating the link and a user account of a user to cause the NFT to be claimed by the user account. For example, the NFT management circuitry 432 and the communication management circuitry 434 shown and described above in connection with FIG. 4A may provide means for transmitting the NFT command.

In an aspect, at block 516, the user device may display, on a display device, one or more digital wallets with which to associate the NFT. For example, the display management circuitry 436 shown and described above in connection with FIG. 4A may provide means for displaying the one or more digital wallets.

In an aspect, at block 518, the user device may receive an input to select a digital wallet out of the one or more digital wallets to associate the selected digital wallet with the NFT. For example, the NFT management circuitry 432 shown and described above in connection with FIG. 4A may provide means for receiving the input to select the digital wallet.

FIG. 5B is a flow chart illustrating an exemplary process 550 for claiming one or more NFTs by a user device, continuing from the flow chart of FIG. 5A, according to some aspects. As described below, some or all illustrated features may be omitted in a particular implementation within the scope of the present disclosure, and some illustrated features may not be required for implementation of all embodiments. In some examples, the process 550 may be carried out by the user device 400 illustrated in FIG. 4A. In some examples, the process 550 may be carried out by any suitable apparatus or means for carrying out the functions or algorithm described below.

In an aspect, at block 552, the user device may receive, from the NFT server device, an indication that the NFT has been claimed by the user account. For example, the communication management circuitry 434 shown and described above in connection with FIG. 4A may provide means for receiving the indication.

In an aspect, at block 554, the user device may display, on a display device, a visual representation associated with the physical object and the NFT. For example, the display management circuitry 436 shown and described above in connection with FIG. 4A may provide means for displaying the visual representation.

In an aspect, at block 556, the user device may perform a subsequent scan of the access information on the physical object after the NFT is claimed by the user account. For example, the scanning circuitry 430 shown and described above in connection with FIG. 4A may provide means for performing the subsequent scan.

In an aspect, at block 558, the user device may transmit, to the NFT server device, a verification request according to the link. For example, the NFT management circuitry 432 and the communication management circuitry 434 shown and described above in connection with FIG. 4A may provide means for transmitting the verification request.

In an aspect, at block 560, the user device may receive, from the NFT server device, the verification information to verify ownership of the NFT by the user account. For example, the communication management circuitry 434 shown and described above in connection with FIG. 4A may provide means for receiving the verification information.

In an aspect, at block 562, the user device may perform a subsequent scan of the access information on the physical object after the NFT is claimed by the user account. For example, the scanning circuitry 430 shown and described above in connection with FIG. 4A may provide means for performing the subsequent scan.

In an aspect, at block 564, the user device may receive an ownership transfer command associated with a second user account based on the subsequent scan. For example, the NFT management circuitry 432 shown and described above in connection with FIG. 4A may provide means for receiving the ownership transfer command.

In an aspect, at block 566, the user device may transmit, to the NFT server device, an ownership transfer request according to the link in response to receiving the ownership transfer command, the ownership transfer request indicating the second user account and causing the NFT server device to transfer ownership of the NFT from the user account to the second user account. For example, the NFT management circuitry 432 and the communication management circuitry 434 shown and described above in connection with FIG. 4A may provide means for transmitting the ownership transfer request.

In one configuration, the user device 400 includes means for scanning, using a scanning device, for access information of a physical object, means for determining a link to an NFT associated with the physical object based on the scanned access information, and means for transmitting, to an NFT server device, an NFT command indicating the link and a user account of a user to cause the NFT to be claimed by the user account. In one aspect, the aforementioned means may be the processor(s) 404 shown in FIG. 4A configured to perform the functions recited by the aforementioned means. In another aspect, the aforementioned means may be a circuit or any apparatus configured to perform the functions recited by the aforementioned means.

In the above examples, the circuitry included in the processor 404 is merely provided as an example, and other means for carrying out the described functions may be included within various aspects of the present disclosure, including but not limited to the instructions stored in the computer-readable storage medium 406, or any other suitable apparatus or means described in FIG. 1, and utilizing, for example, the processes and/or algorithms described herein in relation to FIGS. 5A and/or 5B.

FIG. 6A is a flow chart illustrating an exemplary process 600 for claiming one or more NFTs by an NFT server device, according to some aspects. As described below, some or all illustrated features may be omitted in a particular implementation within the scope of the present disclosure, and some illustrated features may not be required for implementation of all embodiments. In some examples, the process 600 may be carried out by the NFT server device 450 illustrated in FIG. 4B. In some examples, the process 600 may be carried out by any suitable apparatus or means for carrying out the functions or algorithm described below.

At block 602, the NFT server device receives, from a user device, an NFT command indicating a link to an NFT associated with a physical object and a user account of a user, wherein the link is based on scanned access information of the physical object. For example, the NFT management circuitry 480 and the communication management circuitry 482 shown and described above in connection with FIG. 4B may provide means for receiving the NFT command. In an aspect, the NFT command may be received in response to an input at the user device to select a claim option to claim the NFT. In an aspect, the link may indicate a web address to claim the NFT.

In an aspect, the access information may be a bar code associated with the physical object. In an aspect, the access information may be included in an electronic chip.

In an aspect, at block 604, the NFT server device may transmit, to the user device, an authentication request associated with the NFT. For example, the NFT management circuitry 480 and the communication management circuitry 482 shown and described above in connection with FIG. 4B may provide means for transmitting the authentication request.

In an aspect, at block 606, the NFT server device may receive, from the user device, an authentication information in response to the authentication request. In this aspect, the NFT may be claimed by the user account based on the authentication information. For example, the NFT management circuitry 480 and the communication management circuitry 482 shown and described above in connection with FIG. 4B may provide means for receiving the authentication information.

At block 608, the NFT server device causes the NFT to be claimed by the user account in response to the NFT command. For example, the NFT management circuitry 480 shown and described above in connection with FIG. 4B may provide means for causing the NFT to be claimed by the user account.

In an aspect, at block 610, the NFT server device may receive, from the user device, an input to select a digital wallet out of one or more digital wallets. For example, the NFT management circuitry 480 and the communication management circuitry 482 shown and described above in connection with FIG. 4B may provide means for receiving the input to select the digital wallet.

In an aspect, at block 612, the NFT server device may associate the selected digital wallet with the NFT. For example, the NFT management circuitry 480 shown and described above in connection with FIG. 4B may provide means for associating the selected digital wallet with the NFT.

In an aspect, at block 614, the NFT server device may transmit, to the user device, an indication that the NFT has been claimed by the user account to cause the user device to display a visual representation associated with the physical object and the NFT. For example, the NFT management circuitry 480 and the communication management circuitry 482 shown and described above in connection with FIG. 4B may provide means for transmitting the indication that the NFT has been claimed.

FIG. 6B is a flow chart illustrating an exemplary process 650 for claiming one or more NFTs by an NFT server device, continuing from the flowchart of FIG. 6B, according to some aspects. As described below, some or all illustrated features may be omitted in a particular implementation within the scope of the present disclosure, and some illustrated features may not be required for implementation of all embodiments. In some examples, the process 650 may be carried out by the NFT server device 450 illustrated in FIG. 4B. In some examples, the process 650 may be carried out by any suitable apparatus or means for carrying out the functions or algorithm described below.

In an aspect, at block 652, the NFT server device may receive, from the user device, a verification request according to the link in response to a subsequent scan of the access information by the user device after the NFT is claimed by the user account. For example, the NFT management circuitry 480 and the communication management circuitry 482 shown and described above in connection with FIG. 4B may provide means for receiving the verification request.

In an aspect, at block 654, the NFT server device may transmit, to the user device, the verification information to verify ownership of the NFT by the user account. For example, the NFT management circuitry 480 and the communication management circuitry 482 shown and described above in connection with FIG. 4B may provide means for transmitting the verification information.

In an aspect, at block 656, the NFT server device may receive, from the user device, an ownership transfer request according to the link based on a subsequent scan of the access information by the user device after the NFT is claimed by the user account, the ownership transfer request indicating a second user account. For example, the NFT management circuitry 480 and the communication management circuitry 482 shown and described above in connection with FIG. 4B may provide means for receiving the ownership transfer request.

In an aspect, at block 658, the NFT server device may transfer ownership of the NFT from the user account to the second user account. For example, the NFT management circuitry 480 shown and described above in connection with FIG. 4B may provide means for transferring the ownership of the NFT.

In one configuration, the NFT server device 450 includes means for receiving, from a user device, an NFT command indicating a link to an NFT associated with a physical object and a user account of a user, wherein the link is based on scanned access information of the physical object, and means for causing the NFT to be claimed by the user account in response to the NFT command. In one aspect, the aforementioned means may be the processor(s) 454 shown in FIG. 4B configured to perform the functions recited by the aforementioned means. In another aspect, the aforementioned means may be a circuit or any apparatus configured to perform the functions recited by the aforementioned means.

In the above examples, the circuitry included in the processor 454 is merely provided as an example, and other means for carrying out the described functions may be included within various aspects of the present disclosure, including but not limited to the instructions stored in the computer-readable storage medium 456, or any other suitable apparatus or means described in FIG. 1, and utilizing, for example, the processes and/or algorithms described herein in relation to FIGS. 6A and/or 6B.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-6 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-6 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user device for claiming one or more non-fungible tokens (NFTs), comprising:
at least one processor;
a communication device communicatively coupled to the at least one processor; and
a memory communicatively coupled to the at least one processor,
wherein the at least one processor is configured to:
scan, using a scanning device, for access information of a physical object; and
determine a link to an NFT associated with the physical object based on the scanned access information; and
transmit, to an NFT server device, an NFT command indicating the link and a user account of a user to cause the NFT to be claimed by the user account.

2. The user device of claim 1, wherein the at least one processor is further configured to:
receive, from the NFT server device, an authentication request associated with the NFT;
transmit an authentication information to the NFT server device in response to the authentication request,
wherein the NFT is claimed by the user account based on the authentication information.

3. The user device of claim 1, wherein the access information is a bar code associated with the physical object.

4. The user device of claim 3, wherein the bar code is printed on the physical object, and wherein the scanning device is an image capturing device configured to capture the bar code.

5. The user device of claim 1, wherein the access information is included in an electronic chip embedded in the physical object, and
wherein the scanning device is a chip reading device configured to wirelessly read the access information from the electronic chip.

6. The user device of claim 1, wherein the at least one processor is further configured to:
display, on a display device, a claim option to claim the NFT;
receive an input to select the claim option to claim the NFT,
wherein the NFT command is transmitted in response to receiving the input to select the claim option.

7. The user device of claim 1, wherein the at least one processor is further configured to:
display, on a display device, one or more digital wallets with which to associate the NFT; and
receive an input to select a digital wallet out of the one or more digital wallets to associate the selected digital wallet with the NFT.

8. The user device of claim 1, wherein the at least one processor is further configured to:
perform a subsequent scan of the access information on the physical object after the NFT is claimed by the user account;
transmitting, to the NFT server device, a verification request according to the link; and
receive, from the NFT server device, verification information to verify ownership of the NFT by the user account.

9. The user device of claim 1, wherein the at least one processor is further configured to:
perform a subsequent scan of the access information on the physical object after the NFT is claimed by the user account;
receive an ownership transfer command associated with a second user account based on the subsequent scan; and
transmitting, to the NFT server device, an ownership transfer request according to the link in response to receiving the ownership transfer command, the ownership transfer request indicating the second user account and causing the NFT server device to transfer ownership of the NFT from the user account to the second user account.

10. The user device of claim 1, wherein the at least one processor is further configured to:
receive, from the NFT server device, an indication that the NFT has been claimed by the user account; and
display, on a display device, a visual representation associated with the physical object and the NFT.

11. The user device of claim 1, wherein the link indicates a web address to claim the NFT.

12. A non-fungible token (NFT) server device for claiming one or NFTs, comprising:
at least one processor;
a communication device communicatively coupled to the at least one processor; and
a memory communicatively coupled to the at least one processor,
wherein the at least one processor is configured to:
receive, from a user device, an NFT command indicating a link to an NFT associated with a physical object and a user account of a user, wherein the link is based on scanned access information of the physical object; and
cause the NFT to be claimed by the user account in response to the NFT command.

13. The NFT server device of claim 12, wherein the at least one processor is further configured to:
transmit, to the user device, an authentication request associated with the NFT;
receive, from the user device, an authentication information in response to the authentication request,
wherein the NFT is claimed by the user account based on the authentication information.

14. The NFT server device of claim 12, wherein the access information is a bar code associated with the physical object.

15. The NFT server device of claim 12, wherein the access information is included in an electronic chip embedded in the physical object.

16. The NFT server device of claim 12, wherein the at least one processor is further configured to
receive, from the user device, an input to select a digital wallet out of one or more digital wallets; and
associate the selected digital wallet with the NFT.

17. The NFT server device of claim 12, wherein the at least one processor is further configured to:
receive, from the user device, a verification request according to the link in response to a subsequent scan of the access information by the user device after the NFT is claimed by the user account; and
transmit, to the user device, verification information to verify ownership of the NFT by the user account.

18. The NFT server device of claim 12, wherein the at least one processor is further configured to:
receive, from the user device, an ownership transfer request according to the link based on a subsequent scan of the access information by the user device after the NFT is claimed by the user account, the ownership transfer request indicating a second user account; and
transfer ownership of the NFT from the user account to the second user account.

19. The NFT server device of claim 12, wherein the at least one processor is further configured to:
transmit, to the user device, an indication that the NFT has been claimed by the user account to cause the user device to display a visual representation associated with the physical object and the NFT.

20. A system for claiming one or more non-fungible tokens (NFTs), comprising:
an NFT server configured to manage claiming of the one or more NFTs; and
a user device including at least one processor, a communication device communicatively coupled to the at least one processor, and a memory communicatively coupled to the at least one processor, wherein the at least one processor is configured to:
scan, using a scanning device, for access information of a physical object; and
determine a link to an NFT associated with the physical object based on the scanned access information; and
transmit, to the NFT server device, an NFT command indicating the link and a user account of a user to cause the NFT to be claimed by the user account,
wherein the NFT server is configured to cause the NFT to be claimed by the user account in response to receiving the NFT command.
